(19) United States
(12) Patent Application Publication
(10) Pub. No.: US 2011/0086631 A1
(43) Pub. Date: Apr. 14, 2011

(54) METHOD FOR CONTROLLING PORTABLE DEVICE, DISPLAY DEVICE, AND VIDEO SYSTEM

(75) Inventors: Jong-in PARK, Suwon-si (KR); Hyun-chul Seo, Seoul (KR)

(73) Assignee: Samsung Electronics Co., Ltd., Suwon-si (KR)

(21) Appl. No.: 12/903,589

(22) Filed: Oct. 13, 2010

(30) Foreign Application Priority Data
Oct. 13, 2009 (KR) 10-2009-0097374

(51) Int. Cl. H04M 3/00; G10L 15/00; H04N 5/44

(52) U.S. Cl. 455/419; 704/270; 348/734; 704/E15.001; 348/E05.096

(57) ABSTRACT

A method for controlling a portable device, a display device, and a video system is provided. According to the method for controlling the portable device, the portable device transmits an application to the display device, the portable device and the display device execute the application, the portable device receives specific information from a user and transmits the specific information to the display device, and the display device controls an execution of the application according to the specific information. Therefore, a user may control a display device using a portable device.

### PRIORITY

This application claims priority under 35 U.S.C. §119 to Korean Patent Application No. 10-2009-0097374, filed on Oct. 13, 2009, in the Korean Intellectual Property Office, the disclosure of which is incorporated herein by reference in its entirety.

### BACKGROUND OF THE INVENTION

1. Field of the Invention

The present invention generally relates to a method for controlling a portable device, a display device, and a video system, and more particularly, to a method for controlling a portable device, a display device, and a video system, which allows a user manipulation to be input to a display device using a mobile phone.

2. Description of the Related Art

Generally, a television (TV) is controlled by a remote controller. With the development of TV manufacturing techniques, TVs provide various functions and execute various applications. However, remote controllers typically cannot receive various manipulations by a user due to limitations in their functions. In order to enhance the functions of the remote controller, it is necessary to increase the price of a remote controller. However, users generally are not willing to pay extra for remote controllers.

A mobile phone is one of the necessities of modern life, and people carry a mobile phone at all times. A mobile phone provides wireless communication, and provides a lot of functions not supported by a remote controller.

Most people desire to use the various functions of a TV easily. Therefore, a method for controlling a display device such as a TV using a mobile phone is required.

### SUMMARY

Embodiments of the present invention overcome at least the above problems and/or disadvantages and other disadvantages not described above.

The present invention provides a method for controlling a portable device, a display device, and a video system, in which the portable device transmits an application to the display device, the portable device and the display device execute the application, the portable device receives specific information from a user and transmits the specific information to the display device, and the display device controls the execution of the application according to the specific information.

According to an aspect of the present invention, there is provided a method for controlling a portable device communicable with a display device, the method including storing a first application which is executed on the portable device and a second application which is executed on the display device; executing the first application; and transmitting the second application to the display device.

The method may further include receiving specific information from a user; and transmitting the specific information to the display device while the second application is executed on the display device.

The method may further include communicably connecting the portable device to another portable device; and transmitting the first application to the another portable device.

The method may further include transmitting user information to the display device.

According to another aspect of the present invention, there is provided a method for controlling a display device communicably connected to a portable device which stores a first application executed on the portable device and a second application executed on the display device, the method including receiving the second application from the portable device while the first application is executed on the portable device; executing the received second application; receiving specific information from the portable device while the first application is executed on the portable device; and controlling an execution of the second application according to the received specific information.

The method may further include communicably connecting the portable device to another portable device; receiving specific information from the another portable device while the first application is executed on the another portable device; and controlling an execution of the second application according to the specific information received from the another portable device.

The method may further include receiving user information form the portable device; and recognizing a user of the portable device using the received user information.

According to another aspect of the present invention, there is provided a method for controlling a video system having a display device and a portable device which are communicably connected to each other, the method including storing, by the portable device, a first application which is executed on the portable device and a second application which is executed on the display device; executing, by the portable device, the first application; transmitting, by the portable device, the second application to the display device; executing, by the display device, the second application; receiving, by the portable device, specific information from a user; transmitting, by the portable device, the specific information to the display device; and controlling, by the display device, an execution of the second application according to the specific information.

The method may further include communicably connecting the portable device to another portable device; transmitting, by the portable device, the first application to the another portable device; executing, by the another portable device, the first application; receiving, by the another portable device, specific information from a user; transmitting, by the another portable device, the specific information to the display device; and controlling, by the display device, an execution of the second application according to the specific information received from the another portable device.

### BRIEF DESCRIPTION OF THE DRAWINGS

The above and/or other aspects of the present invention will be more apparent by describing certain embodiments of the present invention with reference to the accompanying drawings, in which:

FIG. 1 illustrates a video system having a television (TV) and a mobile phone according to an embodiment of the present invention;

FIG. 2 is a block diagram illustrating a TV and a mobile phone according to an embodiment of the present invention;

FIG. 3 is a flowchart illustrating a method for controlling a TV and a mobile phone according to an embodiment of the present invention;

FIG. 4 is a flowchart illustrating a method for controlling a mobile phone, an other mobile phone, and a TV according to an embodiment of the present invention; and

FIGS. 5A to 5C illustrate the process in which a mobile phone transmits game A to a TV and executes the game A according to an embodiment of the present invention;

FIG. 6 illustrates the process in which if a user inputs a voice to a mobile phone, information on the voice is transmitted to a TV, according to an embodiment of the present invention;

FIG. 7 illustrates the process in which if a user manipulates a mobile phone by touching a screen of the mobile phone, touch information is transmitted to a TV, according to an embodiment of the present invention;

FIG. 8 illustrates the process in which if a user inputs motion information to a mobile phone, the motion information is transmitted to a TV, according to an embodiment of the present invention;

FIG. 9 illustrates the case in which three mobile phones operate in association with a TV, according to an embodiment.

### DETAILED DESCRIPTION OF THE PRESENT INVENTION

Certain embodiments of the present invention will now be described in greater detail with reference to the accompanying drawings.

In the following description, the same drawing reference numerals are used for the same elements even in different drawings. The matters defined in the description, such as detailed construction and elements, are provided to assist in a comprehensive understanding of the invention. Thus, it is apparent that the present invention can be carried out without those specifically defined matters. Also, well-known functions or constructions are not described in detail since they would obscure the invention in unnecessary detail.

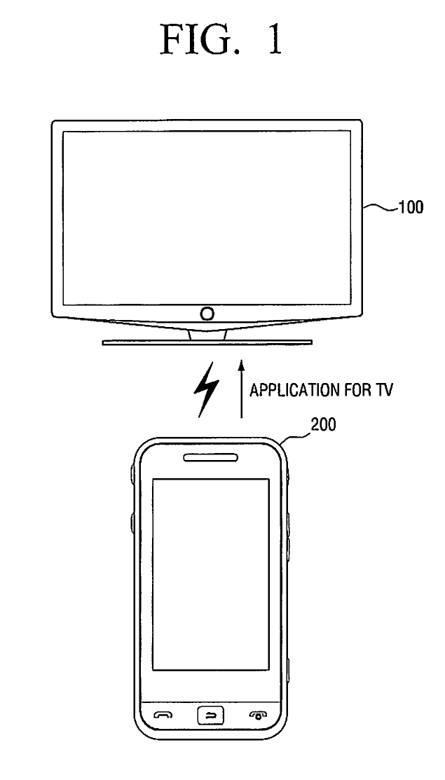

FIG. 1 illustrates a video system having a television (TV) 100 and a mobile phone 200 according to an embodiment of the present invention. Referring to FIG. 1, the TV 100 and the mobile phone 200 are communicably connected to each other over a wireless network such as by Bluetooth®, Zigbee, a Wireless Local Area Network (WLAN), etc.

The mobile phone 200 may store or execute applications. To be specific, the mobile phone 200 may store both an application for a TV and an application for a mobile phone. The applications can perform the same function, for example the same game, program, utility, and so on. The mobile phone 200 may also transmit the application for the TV to the TV 100.

Herein, “application for the TV” means an application that is to be executed on the TV. The application for the TV performs the function of displaying various information and images on a screen. The execution of the application for the TV is controlled according to information input from the mobile phone 200.

“Application for the mobile phone” means an application that is to be executed on the mobile phone. The application for the mobile phone performs the function of enabling the mobile phone to be used as a user interface device. That is, the application for the mobile phone includes an application that operates as an interface to control a display device (such as TV 100 in this embodiment).

The application for the TV and the application for the mobile phone are executed in association with each other while the TV 100 is communicably connected to the mobile phone 200. Therefore, if a user manipulates the mobile phone 200 in a desirable manner while the application for the TV and the application for the mobile phone are executed, the TV 100 may control the execution of the application for the TV according to the manipulation.

For instance, a quiz game application for the TV displays quiz questions, whether an answer is correct or not, and how the quiz game develops on the TV 100. The application for the mobile phone allows the mobile phone 200 to receive an answer. Therefore, the TV 100 displays a quiz content on a screen, and the mobile phone 200 receives a quiz answer from a user. Any application that can be executed on the TV 100 and the mobile phone 200 may be applicable to the present invention. For instance, various kinds of applications such as a game application, a video application, and so on may be applicable to the present invention.

As described above, if the video system having the TV 100 and the mobile phone 200 is used, a user may control the application that is executed on the TV 100 using the mobile phone 200. In addition, a user may store a desired application in the mobile phone 200 and then transmit the application to the TV 100. Therefore, a user may conveniently carry an application.

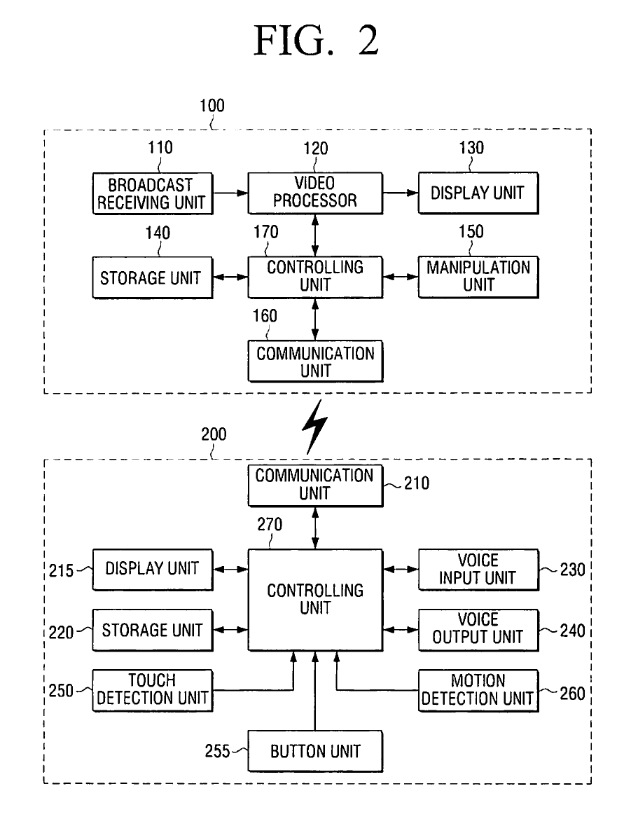

FIG. 2 is a block diagram illustrating the TV 100 and the mobile phone 200 according to an embodiment of the present invention. Referring to FIG. 2, the TV 100 includes a broadcast receiving unit 110, a video processor 120, a display unit 130, a storage unit 140, a manipulation unit 150, a communication unit 160, and a controlling unit 170.

The broadcast receiving unit 110 receives a broadcast signal from a broadcast station or a satellite over wire or wirelessly, and demodulates the received broadcast signal. The broadcast receiving unit 110 transmits the received broadcast signal to the video processor 120.

The video processor 120 processes the broadcast signal transmitted from the broadcast receiving unit 110 by decompressing or clarity correcting the broadcast signal. The video processor 120 transmits a video of the broadcast signal that is decompressed and has enhanced clarity to the display unit 130.

The display unit 130 outputs the video of the broadcast signal transmitted from the video processor 120 on a screen.

The storage unit 140 stores various programs to operate the TV 100. The storage unit 140 also stores various applications. Specifically, the storage unit 140 may store the application for the TV that is received from the mobile phone 200.

The application for the TV allows various information and a video to be displayed on a screen. The execution of the application for the TV is controlled according to the information input from the mobile phone 200.

The storage unit 140 may be implemented as a hard disc drive (HDD), a non-volatile memory, or the like.

The manipulation unit 150 receives a command from a user and transmits the command to the controlling unit 170. The manipulation unit 150 may be implemented as a remote controller (not shown), manipulation buttons (not shown) provided on the TV 100, a touch screen, or the like.

The communication unit 160 can be communicably connected to an external device through a wire or wireless network. Specifically, the communication unit 160 is communicably connected to the mobile phone 200 through a wireless network using Bluetooth®, Zigbee, or a wireless LAN.

The communication unit 160 receives the application for the TV from the mobile phone 200. The communication unit 160 receives manipulation information input by a user from the mobile phone 200.

The controlling unit 170 controls overall operations of the TV 100. To be specific, the controlling unit 170 executes the application for the TV that is received from the mobile phone 200. For example, if a game application for a TV is executed, the controlling unit 170 may include the function of loading a game that is based on a game platform. The controlling unit 170 may further include the function of loading mobile data in order to load the application received from the mobile phone 200.

The controlling unit 170 may receive specific information from the mobile phone 200 while the application for the mobile phone is executed on the mobile phone 200.

Herein, the specific information may be information that allows the application for the TV to be controlled. Specifically, the specific information is information regarding the manipulation input by a user using the mobile phone 200. The information regarding the user's manipulation is input by manipulating the mobile phone 200. The mobile phone 200 may receive voice information, touch information, button manipulation information, and motion information. The specific information may include at least one of the voice information, the touch information, the button manipulation information, and the motion information.

The controlling unit 170 controls the execution of the application for the TV according to the received specific information.

To be specific, if the mobile phone 200 receives voice information as specific information, the controlling unit 170 may receive the voice information from the mobile phone 200. The controlling unit 170 may recognize the received voice information as text information using a voice recognition function, and control the execution of the application for the TV according to the recognized text information.

If the mobile phone 200 receives touch information as specific information, the controlling unit 170 may receive the touch information that is input from the mobile phone 200. The controlling unit 170 controls the execution of the application for the TV according to the received touch information. The controlling unit 170 may recognize the received touch information as text information using a handwriting recognition function. In this case, the controlling unit 170 may control the execution of the application for the TV according to the recognized text information.

If the mobile phone 200 receives button manipulation information as specific information, the controlling unit 170 may receive the button manipulation information from the mobile phone 200. The controlling unit 170 may control the execution of the application for the TV according to the received the button manipulation information.

The mobile phone 200 may receive motion information as specific information. In this case, the controlling unit 170 receives the motion information from the mobile phone 200, and controls the execution of the application for the TV according to the received motion information.

As described above, the controlling unit 170 receives various types of specific information from the mobile phone 200, and controls the execution of the application for the TV according to the specific information.

The controlling unit 170 may receive user information from the mobile phone 200. The controlling unit 170 may recognize a user of the mobile phone 200 through the received user information. By recognizing a user of the mobile phone 200, the controlling unit 170 may identify each mobile phone even if a plurality of mobile phones are connected to the TV 100. Therefore, if a plurality of mobile phones are connected to the TV 100, the controlling unit 170 may identify which mobile phone receives specific information. The controlling unit 170 may enable a plurality of users to use the application for the TV.

As described above, the TV 100 receives the application for the TV and the specific information from the mobile phone 200, and executes or controls the application for the TV.

As shown in FIG. 2, the mobile phone 200 includes a communication unit 210, a display unit 215, a storage unit 220, a voice input unit 230, a voice output unit 240, a touch detection unit 250, a button unit 255, a motion detection unit 260, and a controlling unit 270.

The communication unit 210 is communicably connected to an external device such as TV 100 through a mobile communication network, a wireless communication network, or an Internet network. Herein, the mobile communication network may be a Global System for Mobile communications (GSM), a Wideband Code Division Multiple Access (WCDMA), etc. The wireless communication network is connected through Bluetooth®, Zigbee, etc. The Internet network may be connected, for example, through a wireless LAN.

The communication unit 210 transmits the application for the TV stored in the storage unit 220 to the TV 100. The communication unit 210 transmits specific information to the TV 100. Herein, the specific information refers to the information for controlling the application for the TV. To be specific, the specific information may include information regarding a user command which is input through the voice input unit 230, the touch detection unit 250, the button unit 255, and the motion detection unit 260 of the mobile phone 200, or information regarding a result processed by the controlling unit 270 of the mobile phone 200.

The display unit 215 may display an image that provides functions of the mobile phone 200. The display unit 215 may display Graphic User Interfaces (GUIs) that enable a user to manipulate the mobile phone 200 on a screen. Specifically, the display unit 215 may display a screen that shows the process of executing the application for the mobile phone.

The storage unit 220 may store various programs that allow various functions supported by the mobile phone 200 to be executed. The storage unit 220 may store various types of application. To be specific, the storage unit 220 may store both the application for the TV and the application for the mobile phone.

Herein, the application for the TV means an application that is provided to be executed on the TV. The application for the TV performs the function of displaying various information and images on a screen. The execution of the application for the TV may be controlled according to information which is input from the mobile phone 200.

The application for the mobile phone performs the function of enabling the mobile phone to be used as a user interface device. That is, the application for the mobile phone includes an application which operates as an interface for controlling a display device (such as TV 100).

The storage unit 220 may be implemented as a hard disc memory, a non-volatile memory, etc.

The voice input unit 230 may receive a voice of a user. To be specific, the voice input unit 230 may convert a user voice into voice information which is in the form of an electrical signal, and then transmit the converted voice information to the controlling unit 270.

The voice output unit 240 outputs a voice signal transmitted by the controlling unit 270 via, for example, a speaker.

The touch detection unit 250 may detect information input by a touch by a user. Specifically, the touch detection unit 250 may be implemented as a touch screen that can detect the presence and location of a touch within a display screen. The touch detection unit 250 transmits the touch information to the controlling unit 270.

The button unit 255 may receive a button manipulation from a user. The button unit 255 transmits the button manipulation information to the controlling unit 270.

The motion detection unit 260 may detect motion information on the movement of the mobile phone 200. Specifically, the motion detection unit 260 may be implemented using an acceleration sensor, a gyroscope sensor, etc. The motion detection unit 260 transmits the detected motion information to the controlling unit 270.

The controlling unit 270 controls overall operations of the mobile phone 200. To be specific, the controlling unit 270 may execute the application for the mobile phone stored in the storage unit 220. Under the control of the controlling unit 270 the application for the TV stored in the storage unit 220 may be transmitted to the TV 100.

While the application for the mobile phone is executed, the controlling unit 270 receives specific information according to a user manipulation, and transmits the received specific information to the TV 100. The mobile phone 200 may receive information on a user voice through the voice input unit 230, information on a user touch through the touch detection unit 250, information on a button manipulation through the button unit 255, and information on a movement of the mobile phone 200 through the motion detection unit 260. Accordingly, if specific information relates to a user manipulation, the specific information may be at least one of voice information, touch information, button manipulation information, motion information, and so on.

Specifically, if voice information is input through the voice input unit 230 as the specific information, the controlling unit 270 transmits the input voice information to the TV 100. If touch information is input through the touch detection unit 250 as the specific information, the controlling unit 270 transmits the input touch information to the TV 100. If button manipulation information is input through the button unit 255 as the specific information, the controlling unit 270 transmits the input button manipulation information to the TV 100. If motion information is input through the motion detection unit 260 as the specific information, the controlling unit 270 transmits the input motion information to the TV 100.

As described above, the mobile phone 200 receives specific information from a user and transmits the specific information to the TV 100.

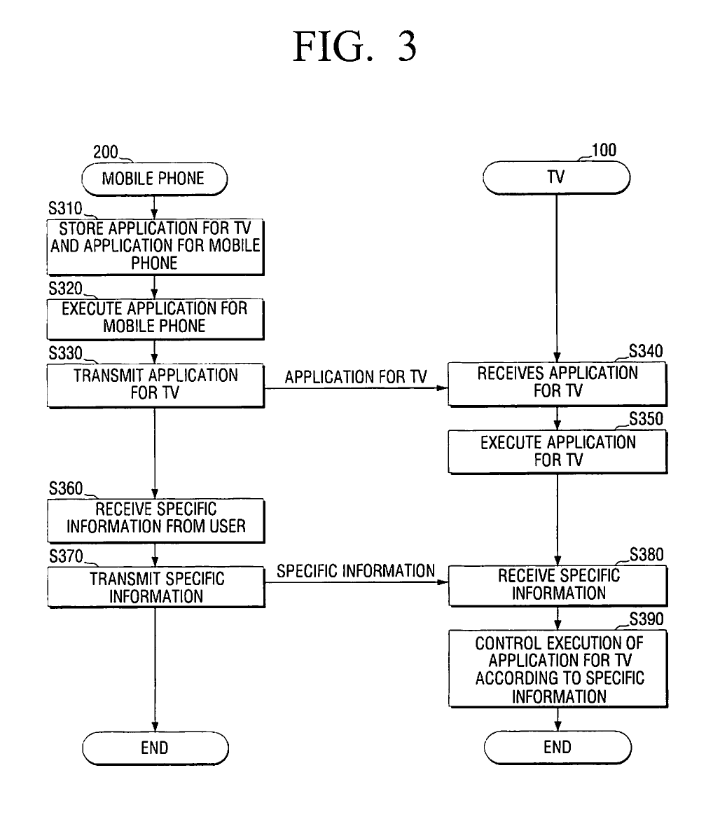

Hereinbelow, a method for controlling the TV 100 and the mobile phone 200 will be explained in detail with reference to FIG. 3. FIG. 3 is a flowchart illustrating a method for controlling the TV 100 and the mobile phone 200 according to an embodiment of the present invention.

The mobile phone 200 stores the application for the TV and the application for the mobile phone in step S310, and executes the application for the mobile phone in step S320. The mobile phone 200 transmits the application for the TV to the TV 100 in step S330.

The TV 100 receives the application for the TV in step S340, and executes the application for the TV in step S350.

The mobile phone 200 receives specific information according to a user manipulation in step S360. The mobile phone 200 transmits the specific information to the TV 100 in step S370. To be specific, the mobile phone 200 receives any one of voice information through the voice input unit 230, touch information through the touch detection unit 250, button manipulation information through the button unit 255, and motion information of the mobile phone 200 through the motion detection unit 260. Accordingly, the specific information may include at least one of the voice information, the touch information, the button manipulation information, the motion information, and so on, which relate to a user manipulation.

Specifically, if voice information on a user voice is input through the voice input unit 230 as the specific information, the mobile phone 200 transmits the input voice information to the TV 100. If information on a touch is input through the touch detection unit 250 as the specific information, the mobile phone 200 transmits the input touch information to the TV 100. If information on a button manipulation is input through the button unit 255 as the specific information, the mobile phone 200 transmits the input button manipulation information to the TV 100. If motion information is input through the motion detection unit 260 as the specific information, the mobile phone 200 transmits the input motion information to the TV 100.

The TV 100 receives the specific information from the mobile phone 200 in step S380. The TV 100 processes the received specific information, and controls the execution of the application for the TV according to the specific information in step S390.

Specifically, if the mobile phone 200 receives information on a user voice as the specific information, the TV 100 receives the voice information from the mobile phone 200. The TV 100 may recognize the received voice information as text information using a voice recognition function, and control the execution of the application for the TV according to the recognized text information.

If the mobile phone 200 receives information input as a user's touch as the specific information, the TV 100 receives the touch information from the mobile phone 200. The TV 100 controls the execution of the application for the TV according to the received touch information. The TV 100 may recognize the received touch information as text information using a handwriting recognition function. In this case, the TV 100 may control the execution of the application for the TV according to the recognized text information.

If mobile phone 200 receives the button manipulation information as the specific information, the TV 100 receives the button manipulation information from the mobile phone 200, and controls the execution of the application for the TV according to the received button manipulation information.

If mobile phone 200 receives the motion information as the specific information, the TV 100 receives the motion information from the mobile phone 200, and controls the execution of the application for the TV according to the received motion information.

As described above, the TV 100 receives various types of specific information from the mobile phone 200, and controls the execution of the application for the TV according to the specific information. In addition, since the mobile phone 200 stores not only the application for the mobile phone but also the application for the TV, a user may execute the application for the TV 100 while the mobile phone 200 operates in association with the desired TV 100.

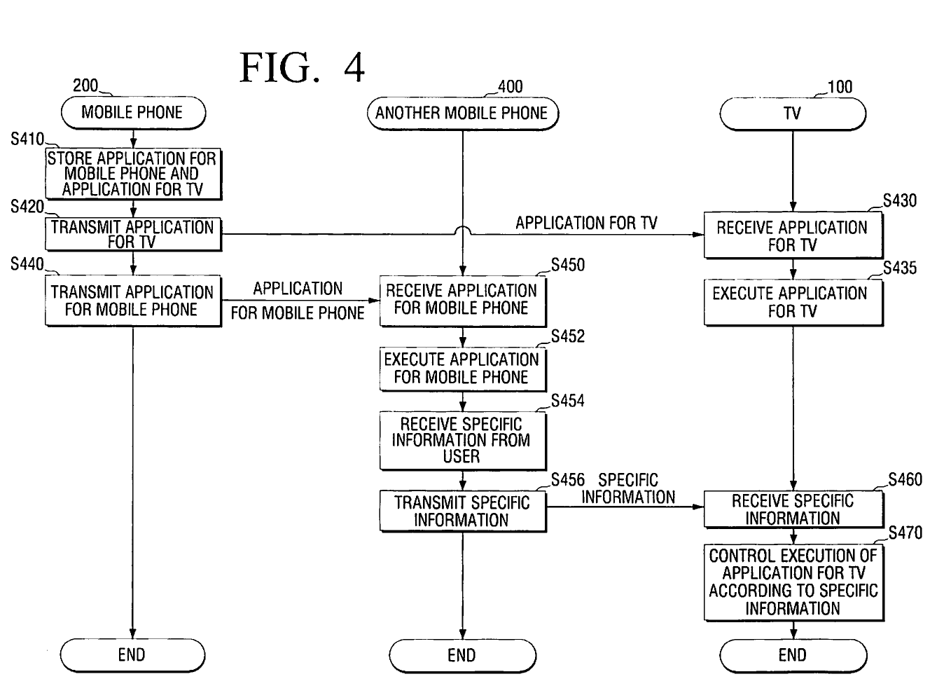

Hereinbelow, a method for controlling mobile phone 200, an other mobile phone 400, and the TV 100 will be explained in detail with reference to FIG. 4. FIG. 4 is a flowchart illustrating a method for controlling mobile phone 200, an other mobile phone 400, and the TV 100 according to an embodiment of the present invention. Herein, while it is assumed that the other mobile phone 400 has the same structure as that of the mobile phone 200, this should not be considered limiting.

The mobile phone 200 stores the application for the mobile phone and the application for the TV in step S410. The mobile phone 200 transmits the application for the TV to the TV 100 in step S420.

The TV 100 receives the application for the TV in step S430, and executes the received application for the TV in step S435.

The mobile phone 200 transmits the application for the mobile phone to the other mobile phone 400 in step S440. The other mobile phone 400 receives the application for the mobile phone in step S450. The other mobile phone 400 executes the application for the mobile phone in step S452.

The other mobile phone 400 receives specific information according to a user manipulation in step S454. The other mobile phone 400 transmits the received specific information to the TV in step S456. Specifically, the other mobile phone 400 receives information on a user voice through the voice input unit, information on a user touch through the touch detection unit, information on a button manipulation through the button unit, and information on a movement of the other mobile phone 400 through the motion detection unit. Accordingly, specific information may include at least one of the voice information, the touch information, the button manipulation information, the motion information, and so on, which relate to a user manipulation.

If information on a user voice is input through the voice input unit as the specific information, the other mobile phone 400 transmits the input voice information to the TV 100. If information on a touch is input through the touch detection unit as the specific information, the other mobile phone 400 transmits the input touch information to the TV 100. If information on a button manipulation is input through the button unit as the specific information, the other mobile phone 400 transmits the input button manipulation information to the TV 100. If motion information is input through the motion detection unit as the specific information, the other mobile phone 400 transmits the input motion information to the TV 100.

The TV 100 receives the specific information from the other mobile phone 400 in step S460. The TV 100 processes the received specific information, and controls the execution of the application for the TV according to the specific information in step S470.

Specifically, if the other mobile phone 400 receives information on a user voice as the specific information, the TV 100 receives the voice information from the other mobile phone 400. The TV 100 recognizes the received voice information as text information using a voice recognition function, and controls the execution of the application for the TV according to the recognized text information.

If the other mobile phone 400 receives information on a user touch as the specific information, the TV 100 receives the received touch information from the other mobile phone 400. The TV 100 controls the execution of the application for the TV according to the received touch information. The TV 100 may recognize the received touch manipulation as text information using a handwriting recognition function. In this case, the TV 100 controls the execution of the application for the TV according to the recognized text information.

If other mobile phone 400 receives information on a button manipulation as the specific information, the TV 100 receives the input button manipulation information from the other mobile phone 400, and controls the execution of the application for the TV according to the received button manipulation information.

If other mobile phone 400 receives motion information as specific information, the TV 100 receives the motion information from the other mobile phone 400, and controls the execution of the application for the TV according to the received motion information.

As described above, the TV 100 receives various types of specific information from the other mobile phone 400, and controls the execution of the application for the TV according to the specific information. In addition, since the mobile phone 200 transmits the application for the mobile phone to the other mobile phone 400, a user may execute the application for the TV 100 while the other mobile phone 400 as well as the mobile phone 200 operates in association with the desired TV 100.

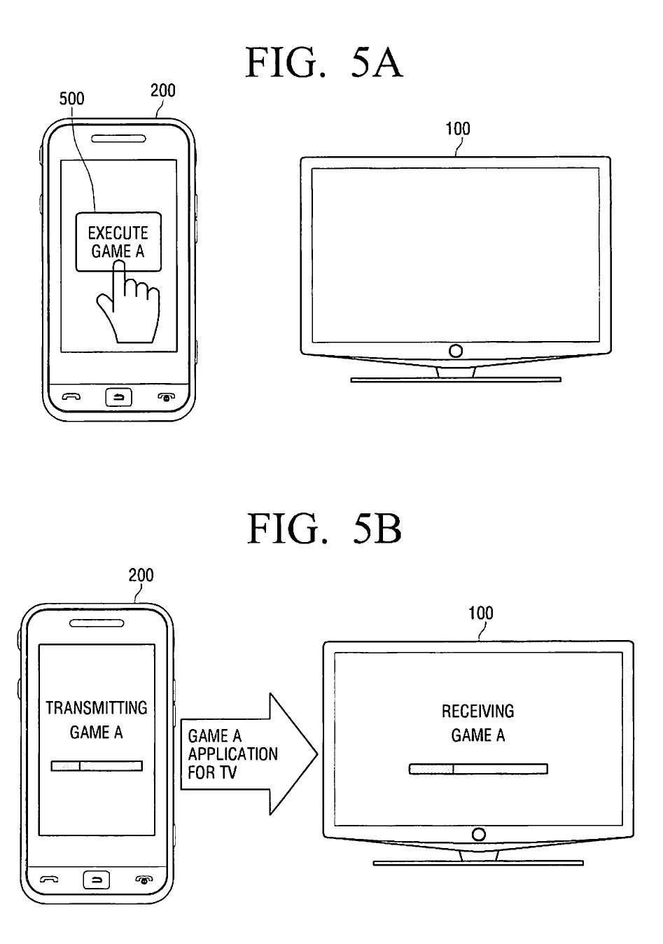

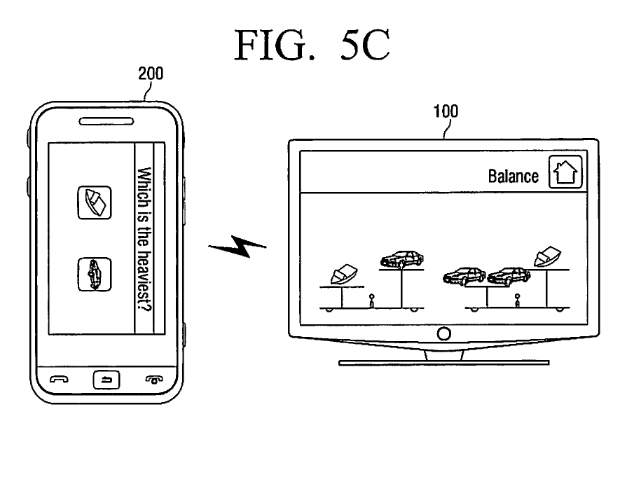

FIGS. 5A to 5C illustrate the process in which the mobile phone 200 transmits game A to the TV 100 and executes the game A according to an embodiment of the present invention.

FIG. 5A shows an icon 500 for executing the game A displayed on a screen of the mobile phone 200. In FIG. 5A, the game A-application is stored in the mobile phone 200. Herein, the application of the game A includes an application for a mobile phone and an application for a TV.

Referring to FIG. 5A, if a user touches the icon 500 for executing the game A, the mobile phone 200 may be ready to execute the game A in association with the TV 100. That is, as shown in FIG. 5B, the mobile phone 200 transmits the game A-application for the TV to the TV 100.

Once the game A-application for the TV is completely transmitted, the mobile phone 200 and the TV 100 execute the game A in association with each other as shown in FIG. 5C.

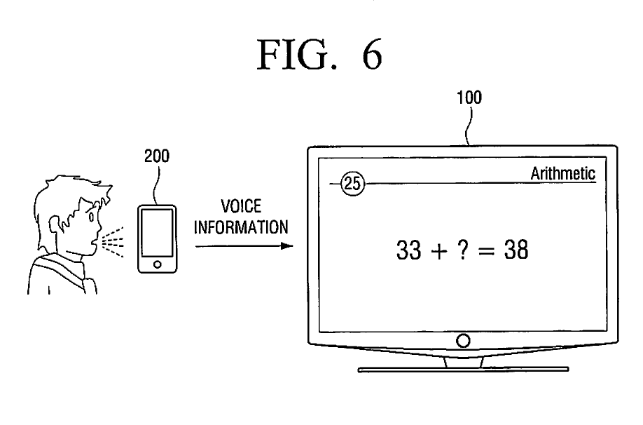

Hereinbelow, the process of transmitting various types of specific information input to the mobile phone 200 to the TV 100 while an application of a quiz is executed will be explained with reference to FIGS. 6 to 8.

FIG. 6 illustrates the process in which if a user inputs a voice to the mobile phone 200, information on the voice is transmitted to the TV 100. Referring to FIG. 6, if a user inputs a voice to the mobile phone 200 in order to answer a quiz, the mobile phone 200 transmits information on the voice to the TV 100. Then, the TV 100 processes the received voice information, and executes a quiz application for the TV in order to determine whether the answer is correct or not.

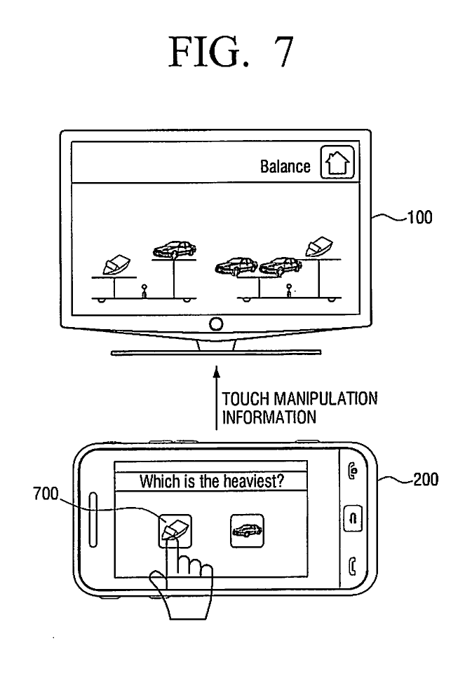

FIG. 7 illustrates the process in which if a user manipulates the mobile phone 200 by touching a screen of the mobile phone 200, information on the touch is transmitted to the TV 100. Referring to FIG. 7, if a user touches an icon 700 on a screen of the mobile phone 200 in order to answer a quiz, the mobile phone 200 transmits information on the touch to the TV 100. Then, the TV 100 processes the received touch information, and executes a quiz application for the TV in order to determine whether the answer is correct or not.

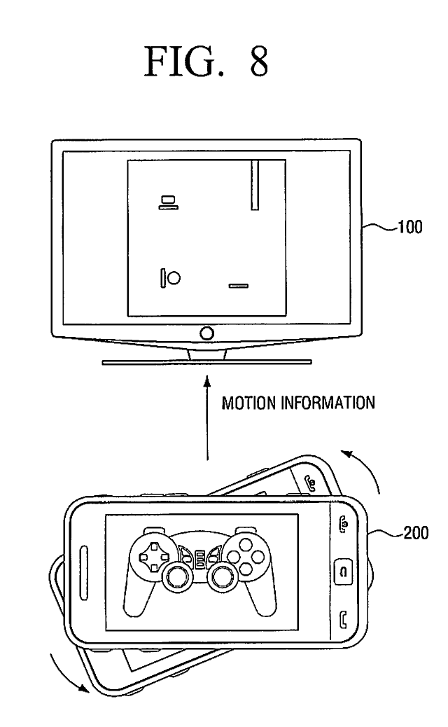

FIG. 8 illustrates the process in which if a user inputs motion information to the mobile phone 200, the motion information is transmitted to the TV 100. Referring to FIG. 8, if a user moves the mobile phone 200 in order to answer a quiz, the mobile phone 200 transmits information on the motion to the TV 100. Then, the TV 100 processes the motion information, and executes a quiz application for the TV in order to determine whether the answer is correct or not.

As described above, the mobile phone 200 receives various types of specific information, and transmits the received specific information to the TV 100.

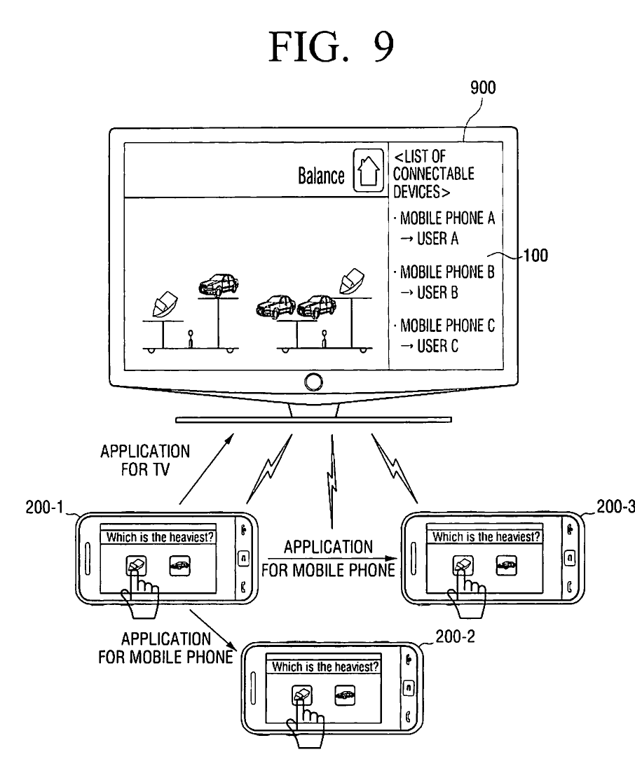

FIG. 9 illustrates the case in which three mobile phones 200-1, 200-2, and 200-3 operate in association with the TV 100, according to an embodiment of the present invention.

In FIG. 9, the first mobile phone 200-1 stores an application for a mobile phone and an application for a TV. The first mobile phone 200-1 transmits the application for the TV to the TV 100. The TV 100 executes the application for the TV as shown in FIG. 9. Then, the first mobile phone 200-1 executes the application for the mobile phone and operates in association with the application for the TV.

The first mobile phone 200-1 transmits the application for the mobile phone to the second and the third mobile phones 200-2 and 200-3. The second and the third mobile phones 200-2 and 200-3 execute the received application for the mobile phone, and thus the application for the mobile phone operates in association with the application for the TV.

Accordingly, the TV 100 is controlled by receiving specific information through the first, the second, and the third mobile phones 200-1, 200-2, and 200-3. That is, the execution of the application for the TV which is executed on the TV 100 may be controlled by the three mobile phones 200-1, 200-2, and 200-3.

The TV 100 may receive user information from each of the first, the second, and the third mobile phones 200-1, 200-2, and 200-3, and may recognize users of the first, the second, and the third mobile phones 200-1, 200-2, and 200-3. As shown in FIG. 9, the TV 100 displays a list 900 listing connectable devices on a screen. In the list 900, users corresponding to each of the connected mobile phones are displayed.

As described above, the first mobile phone 200-1 transmits the application for the mobile phone to the other mobile phones, and thus executes the application for the mobile phone in association with the TV 100.

While the TV 100 is described as the display device, any display device which executes an application may be applicable to the present invention. For example, a display device according to the present invention may be not only the TV 100 but also a monitor, a projector, etc.

In this embodiment, the mobile phone 200 is described as the mobile device. However, any mobile device which executes an application and receives various manipulations may be applicable to the present invention. For example, the mobile device may be a Personal Digital Assistance (PDA), an MPEG layer 3 (MP3) player, a Portable Multimedia Player (PMP), etc, in addition to the mobile phone 200.

The foregoing embodiments and advantages are merely exemplary and are not to be construed as limiting the present invention. The present invention can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. A method for controlling a portable device communicable with a display device, the method comprising:
storing a first application which is executed on the portable device and a second application which is executed on the display device;
executing the first application; and
transmitting the second application to the display device.

2. The method as claimed in claim 1, further comprising:
receiving specific information from a user; and
transmitting the specific information to the display device while the second application is executed on the display device.

3. The method as claimed in claim 2, wherein receiving the specific information comprises receiving information on a user voice as the specific information, and transmitting the specific information comprises transmitting the information on the user voice to the display device.

4. The method as claimed in claim 2, wherein receiving the specific information comprises receiving information on a user touch as the specific information, and transmitting the specific information comprises transmitting the information on the user touch to the display device.

5. The method as claimed in claim 2, wherein receiving the specific information comprises receiving motion information as the specific information, and transmitting the specific information comprises transmitting the motion information to the display device.

6. The method as claimed in claim 1, wherein the first application includes an application which performs an interface function for controlling the display device.

7. The method as claimed in claim 1, wherein the second application includes an application which is executed on the display device, which an execution of which is controlled according to information input from the portable device.

8. The method as claimed in claim 1, further comprising:
communicably connecting the portable device to another portable device; and
transmitting the first application to the another portable device.

9. The method as claimed in claim 1, further comprising transmitting user information to the display device.

10. A method for controlling a display device communicably connected to a portable device which stores a first application executed on the portable device and a second application executed on the display device, the method comprising:
receiving the second application from the portable device while the first application is executed on the portable device;
executing the received second application;
receiving specific information from the portable device while the first application is executed on the portable device; and
controlling an execution of the second application according to the received specific information.

11. The method as claimed in claim 10, wherein when the portable device receives voice information as the specific information,
receiving the specific information comprises receiving the voice information input to the portable device; and
controlling the execution comprises recognizing the received voice information using a voice recognition function, and controlling the execution of the second application according to the recognized information.

12. The method as claimed in claim 10, wherein when the portable device receives touch information as the specific information,
receiving the specific information comprises receiving the touch information input to the portable device; and
controlling the execution comprises recognizing the received information on the touch, and controlling the execution of the second application according to the recognized information.

13. The method as claimed in claim 10, wherein when the portable device receives motion information as the specific information,
receiving the specific information comprises receiving the motion information input to the portable device; and
controlling the execution comprises controlling the execution of the second application according to the received motion information.

14. The method as claimed in claim 10, wherein the first application comprises an application which performs an interface function for controlling the display device.

15. The method as claimed in claim 10, wherein the second application comprises an application which is executed on the display device, and an execution of which is controlled according to information input to the portable device.

16. The method as claimed in claim 10, further comprising:
communicably connecting the portable device to another portable device;
receiving specific information from the another portable device while the first application is executed on the another portable device; and
controlling an execution of the second application according to the specific information received from the another portable device.

17. The method as claimed in claim 10, further comprising:
receiving user information from the portable device; and
recognizing a user of the portable device using the received user information.

18. A method for controlling a video system having a display device and a portable device which are communicably connected to each other, the method comprising:
storing, by the portable device, a first application which is executed on the portable device and a second application which is executed on the display device;
executing, by the portable device, the first application;
transmitting, by the portable device, the second application to the display device;
executing, by the display device, the second application;
receiving, by the portable device, specific information from a user;
transmitting, by the portable device, the specific information to the display device; and
controlling, by the display device, an execution of the second application according to the specific information.

19. The method as claimed in claim 18, further comprising:
communicably connecting the display device and the portable device to another portable device;
transmitting, by the portable device, the first application to the another portable device;
executing, by the another portable device, the first application;
receiving, by the another portable device, specific information from a user;
transmitting, by the another portable device, the specific information to the display device; and
controlling, by the display device, an execution of the second application according to the specific information received from the another portable device.
